(19) United States
(12) Patent Application Publication
(10) Pub. No.: US 2017/0101145 A1
(43) Pub. Date: Apr. 13, 2017

(54) Electric Tricycle Conversion Kit

(71) Applicant: Justino Martinez, JR., Phoenix, AZ (US)

(72) Inventor: Justino Martinez, JR., Phoenix, AZ (US)

(21) Appl. No.: 14/835,397

(22) Filed: Oct. 8, 2015

(51) Int. Cl. B62D 65/12; B62D 65/14; B62M 7/12; B62L 1/00; B62K 5/027; B62K 21/02

(52) U.S. Cl. CPC B62D 65/12; B62K 5/027; B62K 21/02; B62M 7/12; B62L 1/005; B62D 65/14; B62K 2204/00; B62K 2208/00

(57) ABSTRACT

The conversion of a bicycle into an electric tricycle provides a stable means of travel which does not require it to be continuously in motion to remain upright. A person can stop and remain on the tricycle without dismounting or supporting the bicycle. It also provides a means of riding a converted bicycle to those not able to ride a conventional bicycle. The tricycle is an inexpensive means of electric transportation that would reduce traffic congestion and carbon emissions in densely populated areas.

### CROSS-REFERENCE TO RELATED APPLICATIONS

Not Applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not Applicable

### BACKGROUND OF INVENTION

The invention being submitted pertains to the field of mechanical engineering and environmental sustainability. It was developed as a method of utilizing an already existing electric wheel hub to create a stable form of transportation when incorporated with an existing bicycle frame using the proposed conversion kit. The Electric Tricycle Kit would enable the use of a cleaner mode of transportation that would not emit the carbon monoxide particulates of a gas powered engine. The kit provides a stabilizing design that provides the rider with the safety and ease of riding that has not been available in other electric bicycles. The existing electric motor that is incorporated into the wheel hub of a bicycle was designed to convert a bicycle into an electrically powered mode of transportation reaching speeds of up to 35 miles per hour. The speed and the extra weight of the electric motor added to the front of the bicycle make it difficult to control and balance.

The proposed design changes and additions to a bicycle frame allow the rider more stability and control while navigating through traffic. The speed of the electric motor makes this light weight, low maintenance and affordable vehicle able to operate on public streets yet small enough to function in more confined areas. The vehicle is ideal for use in easing congested traffic conditions in downtown areas or areas where mass transportation is not available. The design which uses pneumatic tires on the rear of the tricycle makes it usable in dirt and grass areas where other handicap vehicles are not usable.

### BRIEF SUMMARY OF INVENTION

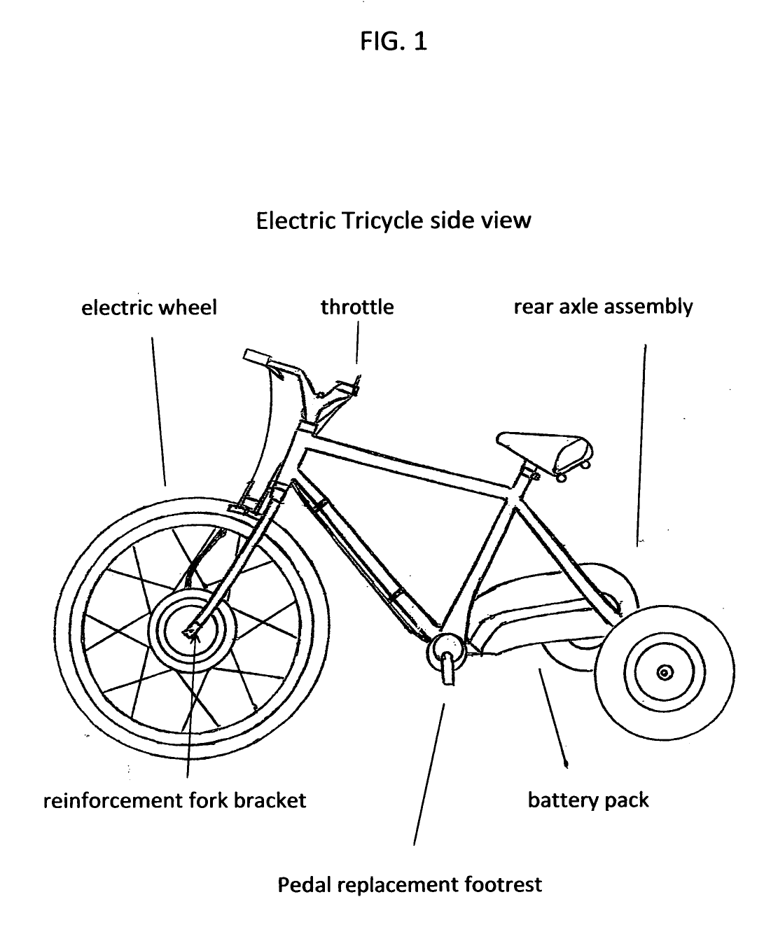

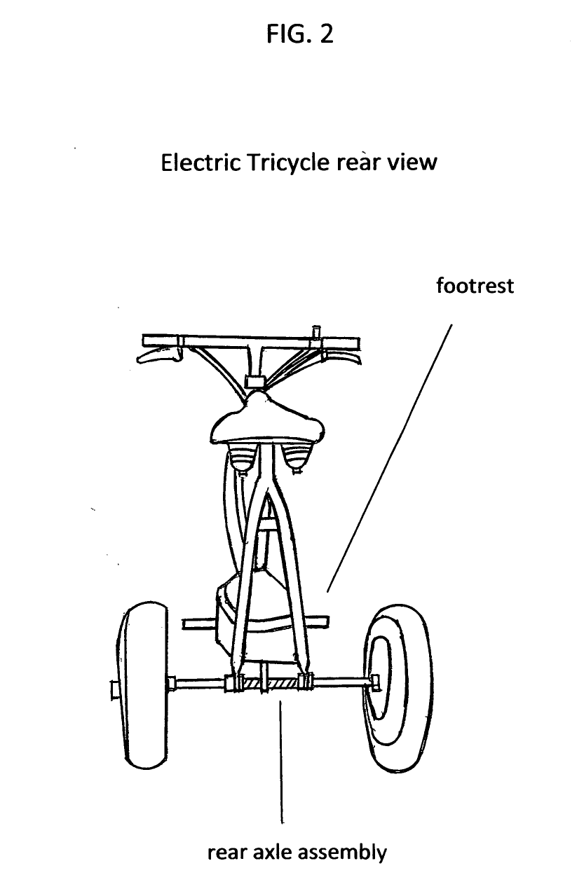

This conversion allows a bicycle to be to become an electric tricycle and remain standing on its own while standing still or in motion, an electric bicycle wheel mounted on the front forks with a set of electric batteries mounted on a bracket on the rear of the bicycle frame provide the drive for the tricycle (see P. 1/6, FIG. 1 & P. 2/6, FIG. 2). This innovation allows for ease of use while riding or parking the electric tricycle.

### BRIEF DESCRIPTION OF THE SEVERAL VIEWS

FIG. 1: This figure depicts the side view of the electric tricycle displaying electric wheel bracket, front brake assembly, footrest, battery pack position, and rear pneumatic wheels.

FIG. 2: This figure depicts the rear view of the electric tricycle displaying the rear axle assembly, pneumatic tires, battery pack, and footrest.

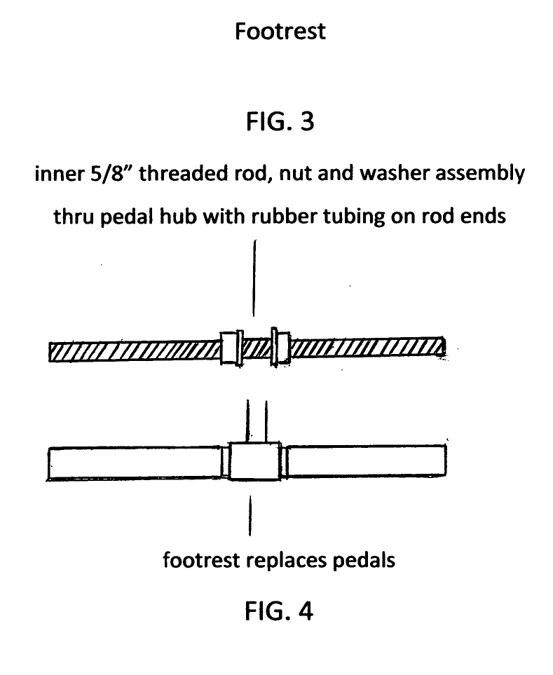

FIG. 3: This figure depicts the threaded rod, nut, and washer assembly for the footrest.

FIG. 4: This figure depicts the footrest that replaces the pedals on a standard bicycle.

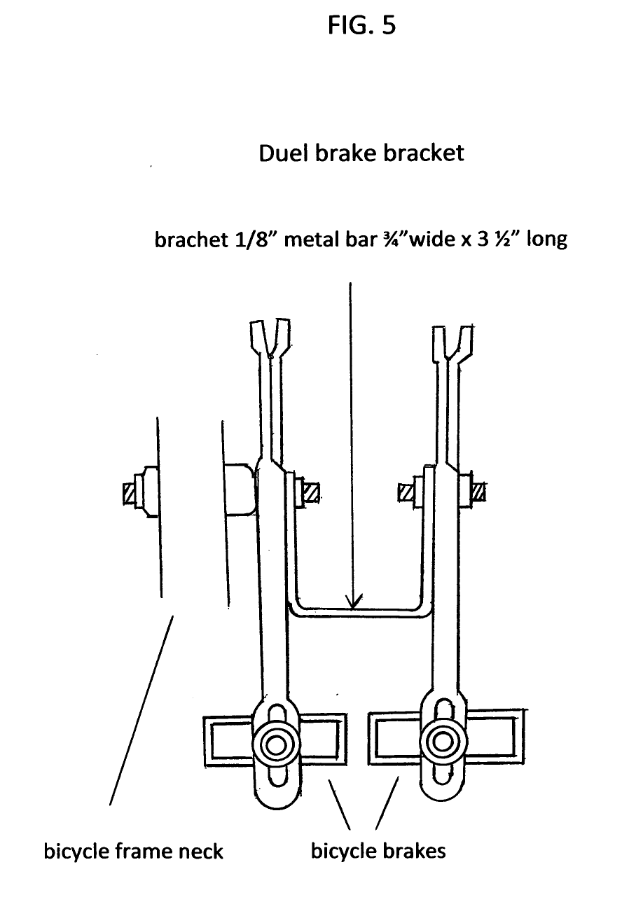

FIG. 5: This figure depicts the front mounted brake bracket on the neck of the bicycle frame that allows for the doubling of standard bicycle brakes on the front wheel.

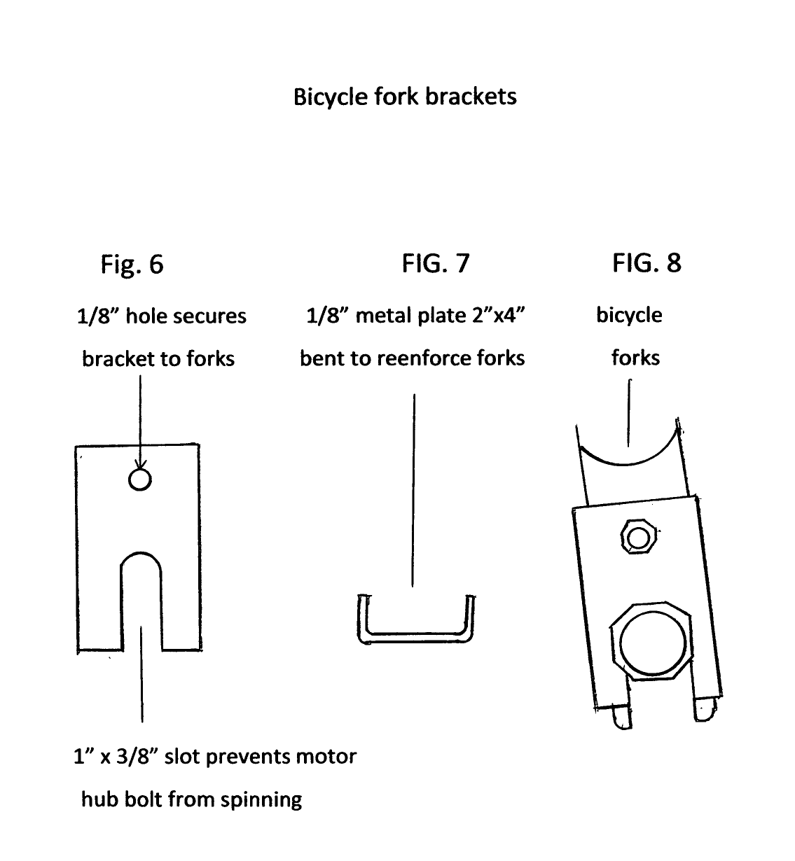

FIG. 6: This figure is a side view of the reinforcement tricycle fork bracket, showing the slot for the electric wheel, and the hole that secures bracket to forks.

FIG. 7: This figure depicts the ½″ metal plate with the bends that reinforce the forks, from the top view.

FIG. 8: This figure depicts the reinforcement bracket on the tricycle forks.

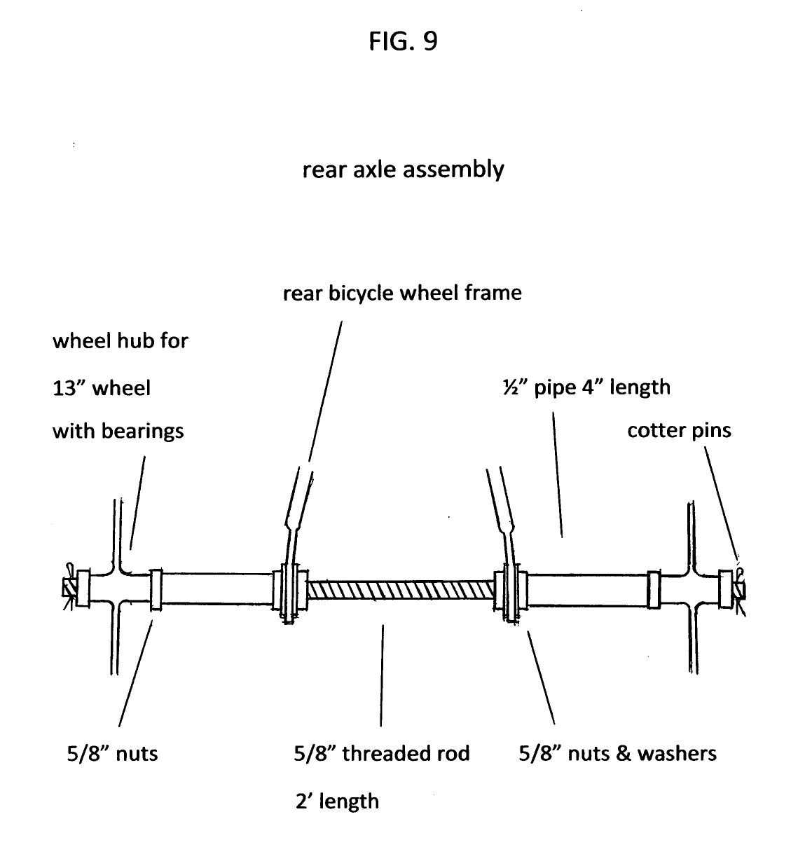

FIG. 9: This figure depicts the tricycle rear axle assembly.

### DETAILED DESCRIPTION OF THE INVENTION

This patent application for an electric tricycle conversion kit consists of a set of brackets for the front forks of a bicycle to reinforce the forks of a standard bicycle and allow for the introduction of the larger wheel bolt necessary for the electric wheels that are currently on the market (see P. 5/6, FIGS. 6,7 & 8). The brackets would allow for a larger wheel bolt and a physical barrier to keep the electric motor from turning the wheel hub bolt, which has flat ends on two sides to prevent the bolt and electric supply line from turning instead of the wheel. The bracket also reinforces the bolt slots on the forks that need to be ground to a larger size to accommodate the electric wheel hub, while it would allow for application to electric tricycles it could also be used for application to an electric bicycle. The rear portion of the kit would consist of a ⅝″ threaded rod, nut, washer and half inch pipe assembly (see P. 6/6, FIG. 9) that would allow a set of rear wheels to be mounted on any standard bicycle. The kit would also include a front mounted bracket on the upper portion of the forks to allow for the doubling of standard bicycle hand brakes onto the front wheel of the tricycle (see P. 4/6, FIG. 5). The doubling of the brakes is necessary to provide a more powerful braking system to compensate for the loss of the rear wheel brake.

The ⅝″ bolt on the rear of the bicycle frame would have two ground or cut slots to allow it to be inserted in any standard bicycle rear wheel bracket. The threaded rod would extend to each side of the original frame of the bicycle and be 4″ in length to provide stability. A half inch pipe of 4″ in length would then be placed over the bolt on each side of the original frame, after tightening the ½″ pipe to the bolts at the frame and the outer ends of the pipe, the tension of the pipe on the bolt would provide enough strength in the assembly to bear the weight of a fully grown person (see P. 6/6, FIG. 9). Two wheels which come with factory installed bearings would then be mounted on the ends with nuts and pins to secure the wheels in place (see P. 6/6, FIG. 9). The pedals would be removed and replaced with a ⅝″ threaded rod 15″ in length with nuts and washers to secure it at the pedal hub, with rubber tubing placed over the threaded rod, it would act as a foot rest, (see P. 3/6, FIGS. 3 & 4).

This conversion allows a bicycle to become an electric tricycle and remain standing on its own while standing still or in motion. An electric bicycle wheel mounted on the front forks with a set of electric batteries mounted on a bracket on the rear of the bicycle frame provide the drive for the tricycle (see P. 1/6, FIG. 2 & P. 2/6, FIG. 2). This innovation allows for ease of use while riding or parking the electric tricycle.

This patent application claims a conversion of a standard bicycle into an electric tricycle by applying the following method:

1. Creating a rear axle rod and pipe assembly to provide a stable upright position.

2. Construct front wheel brackets to accommodate electric wheels currently on the market.

3. Replace the pedals of a bicycle with a foot rest consisting of threaded rod, nut, washer, and rubber tube assembly.

4. Create a front brake bracket providing added braking power to replace loss of rear brakes after conversion.
